(19) United States
(12) Patent Application Publication
(10) Pub. No.: US 2021/0396859 A1
(43) Pub. Date: Dec. 23, 2021

(54) ABSTANDSMESSEINHEIT

(71) Applicant: OSRAM GmbH, Munich (DE)

(72) Inventors: Thomas Rossmanith, Munich (DE); Friedrich Witzani, Munich (DE); Alexander Rampitsch, Ottobrunn (DE)

(73) Assignee: OSRAM GmbH, Munich (DE)

(21) Appl. No.: 17/289,256

(22) PCT Filed: Oct. 23, 2019
(86) PCT No.: PCT/EP2019/078779

§ 371 Date: Apr. 28, 2021

(30) Foreign Application Priority Data
Oct. 31, 2018 (DE) 10 2018 218 706.1

(51) Int. Cl. G01S 7/4865; G01S 17/931; G01S 17/10

(52) U.S. Cl. CPC G01S 7/4865; G01S 17/10; G01S 17/931

(57) ABSTRACT

Systems and methods disclosed herein includes a distance-measuring unit for measuring a distance to an object located in a detection field based on a time-of-flight signal. The distance-measuring unit includes an emitter unit for emitting laser pulses, an optical unit coupling the emitter unit to the detection field, the optical unit configured to guide the laser pulses into the detection field during operation, and a receiver unit having a sensitive sensor surface for receiving laser pulses reflected at the object as echo pulses, wherein the receiver unit is coupled to the detection field by means of the optical unit such that the echo pulses received from the detection field are guided through the optical unit onto the sensor surface during operation.

### TECHNICAL FIELD

The present invention relates to a distance-measuring unit for distance measurement based on a time-of-flight signal.

### PRIOR ART

The distance measurement in question is based on a time-of-flight measurement of emitted electromagnetic pulses. If these pulses strike an object, the pulse is partially reflected at its surface back to the distance-measuring unit and can be recorded as an echo pulse with a suitable sensor. If the emission of the pulse takes place at a time t₀ and if the echo pulse is detected at a later time t₁, the distance d to the reflecting surface of the object may be determined by means of the time-of-flight Δt_{A}=t₁−t₀ according to

d=Δt_{A}c/2. Eq. 1

Since the pulses are electromagnetic pulses, c is the value of the speed of light.

### SUMMARY OF THE INVENTION

The technical object of the present invention is to provide a particularly advantageous distance-measuring unit.

This is achieved according to the invention with the distance-measuring unit as claimed in claim 1. It comprises an emitter unit for emitting the laser pulses and a receiver unit for receiving echo pulses. One particular feature in this case is that the receiver unit and the emitter unit are coupled to the detection field by means of the same optical unit. The echo pulses are thus guided onto the sensor surface of the receiver unit by means of the same optical unit as the one by means of which the laser pulses travel from the emitter unit into the detection field.

This integration may for example be advantageous with a view to a compact structure, as the emitter unit and the receiver unit may be provided relatively close to one another or even integrated at the component level, see below in detail. Moreover, the multiple use of the optical unit per se is already advantageous because, for example, in this way the number of individual parts may be decreased or the adjustment outlay may be reduced. A compact and economical LIDAR sensor system may therefore be produced (Lidar=light detection and ranging).

Preferred configurations may be found in the dependent claims and the disclosure as a whole, distinction not always being made in detail in the presentation of the features between device and method or use aspects; the disclosure is in each case implicitly to be interpreted in respect of all claim categories. For example, if a distance-measuring unit suitable for particular operation is described, this is also intended to include disclosure of a corresponding operating method, and vice versa.

The optical unit is preferably refractive; an exclusively refractive optical unit is particularly preferred, i.e. the guiding of light or radiation takes place only by refraction (reflection is also possible in general). The optical unit is preferably a converging lens, which may be constructed as individual lenses or as a lens system having a plurality of individual lenses. In respect of further possibilities, reference is made to the disclosure below.

A laser diode is preferably provided as the emitter unit. It may for example be a surface emitter (VCSEL), with which integration with the receiver unit (photodiode) at the component level is even possible, see below in detail. On the other hand, however, the laser diode may also be constructed as an edge emitter, i.e. the laser radiation may be emitted at a laser facet on the side edge of the chip.

Also, independently of the structure of the emitter unit in detail, the electromagnetic radiation is preferably infrared radiation, i.e. wavelengths of for example at least 600 nm, 650 nm, 700 nm, 750 nm, 800 nm or 850 nm (increasingly preferred in the order mentioned). Around 905 nm may for example be particularly preferred, in respect of which advantageous upper limits may be at most 1100 nm, 1050 nm, 1000 nm or 950 nm (increasingly preferred in the order mentioned). A further preferred value may for example be around 1064 nm, which entails advantageous lower limits of at least 850 nm, 900 nm, 950 nm or 1000 nm and advantageous upper limits (independent thereof) of at most 1600 nm, 1500 nm, 1400 nm, 1300 nm, 1200 nm or 1150 nm (in each case increasingly preferred in the order mentioned). Preferred values may also be around 1548 nm or 1550 nm, which entails advantageous lower limits of at least 1350 nm, 1400 nm, 1450 nm or 1500 nm and advantageous upper limits (independent thereof) of at most 2000 nm, 1900 nm, 1800 nm, 1700 nm, 1650 nm or 1600 nm (in each case increasingly preferred in the order mentioned). In general, however, wavelengths in the far IR may for example also be envisioned, for example 5600 nm or 8100 nm.

A pulse is a temporally limited quantity which is emitted in order, in the case of reflection at the object, then to be detected by a sensor of the distance-measuring unit with a time lag. A pulse width, taken according to the full width at half maximum (FWHM), may for example be at most 1 ms, and preferably much less, i.e. increasingly preferably in the order mentioned at most 800 μs, 600 μs, 400 μs or 200 μs, or even less, namely at most 1000 ns, 900 ns, 800 ns, 700 ns, 600 ns, 500 ns, 400 ns, 300 ns, 200 ns, 100 ns, 80 ns, 60 ns, 40 ns, 30 ns, 25 ns, 20 ns, 15 ns, 10 ns, 5 ns or 2 ns (increasingly preferred in the order mentioned). In principle, a pulse that is as short as possible may be preferred, although for technical reasons lower limits may for example be at least 0.001 ns, 0.01 ns or 0.1 ns.

In general, the receiver unit may also be provided as a position-resolving receiver unit, i.e. the sensitive sensor surface may be subdivided into a plurality of individually readable regions. An example thereof is a CCD or CMOS array. The receiver unit is preferably provided as a photodiode, specifically without position resolution over the sensor surface. As the photodiode, a PIN diode, APD (avalanche photodiode) or SPAD (single photon APD) is for example possible, or a photomultiplier.

According to one preferred embodiment, the distance-measuring unit comprises a reflector which is arranged between the emitter unit and the optical unit. During operation, the laser pulses of the emitter unit are reflected at the reflector, specifically at the reflection surface thereof, before they travel through the optical unit into the detection field. With this deflection, the same optical unit may for example be used for laser pulses and echo pulses even when the laser diode is configured as an edge emitter and the laser pulses are emitted “laterally”.

In a preferred configuration, the receiver unit and the reflector are positioned relative to one another in such a way that a perpendicular projection of the reflection surface into the sensor surface fills the sensor surface partially but not fully. In other words, the reflection surface shadows a part of the sensor surface as seen from the detection field. This is on the one hand an expression of the integration, because the emitter unit and the receiver unit may therefore actually be assigned to the same spatial direction. On the other hand, the shadowing exists only partially so that an energy fraction from the echo pulses always reaches the sensor surface.

In a preferred configuration, the reflector itself is placed onto the sensor surface and connected thereto. The components, i.e. the receiver unit or photodiode on the one hand, and the reflector on the other hand, are thus stacked on one another, and the reflector is preferably adhesively bonded. The radiation which strikes the “sensor surface” (or at least a fraction thereof and at least in one wavelength range) may be metrologically detected with the receiver unit. The sensor surface is, for example, not necessarily the surface of the photodiode chip, and the latter may for example also be packaged so that a radiation-transmissive window forms the sensor surface.

As an alternative, a laterally suspended reflector may also be preferred, i.e. the reflector may be fastened by means of a suspension element. The latter extends laterally beyond the edge of the sensor surface, and is fastened there, for example adhesively bonded onto the housing of the emitter unit. This variant may, for example, be preferred when adhesive bonding of the reflector onto the sensor surface is not possible, or is possible only with increased outlay.

The reflector may be provided as a reflector made of a nontransmissive material, for example made of a metal such as aluminum, or made of a plastic. The metallic or plastic material may be inherently reflective (for example embedded reflection particles in the case of the plastic) or separately coated (for example with Au or Ag or Al).

In general, it may be preferred for the reflector to be provided as a prismatic body made of a radiation-transmissive material, i.e. a material which transmits at least wavelengths in the range of the laser and echo pulses. The reflector may in particular be provided as a reflector made of a plastic material (for example polycarbonate) or preferably a vitreous material, in particular quartz glass. A coated surface of the reflector (for example coated with Au, Al or Ag) may form the reflection surface.

In a preferred configuration, the reflection surface is a total internal reflection surface, i.e. the laser pulses enter the prismatic body and emerge after total internal reflection (the optical density of the radiation-transmissive material is higher than that of the surrounding medium, for example air). Total internal reflection may, for example, be advantageous in respect of efficiency. Considered in a cross section, the reflector may have a triangular shape, and it may in particular constitute a right-angled triangle. An X cube may also be provided as the prism.

The suspension element, at least in the region of the sensor surface, may have a relatively simple shape, in particular a cuboid shape, in order to reduce unintended reflections. In general, a suspension element having side surfaces that are as parallel as possible to the sensor surface may advantageously allow good radiation transmission (from the detection field onto the sensor surface). In this respect, an at least local antireflection coating of the suspension element may also be preferred, for example at least of those side surfaces thereof which are substantially parallel to the sensor surface.

According to one preferred embodiment, the suspension element is provided monolithically with the reflector and made of the same radiation-transmissive material. “Monolithically” means free from, i.e. without, material boundaries in the interior, i.e. uninterruptedly continuously (for example formed by casting or by machining on the same base body).

In one preferred embodiment, the distance-measuring unit is adapted for solid angle-selective emission of the laser pulses, i.e. they can be emitted selectively into different solid angle segments of the detection field. It is then possible to segmentally “listen” and determine a respective distance value, which gives a one-dimensionally or even two-dimensionally pixelated distance image. In general, this solid angle-selective emission of the pulses may for example also be achieved with a tiltable or oscillating reflection surface, i.e. for example a MEMS mirror. The latter reflects the laser pulses incident from the emitter unit into different solid angle segments in different oscillation or tilt settings, which gives the aforementioned resolution.

In a preferred configuration, however, the solid angle-selective emission is produced with a plurality of emitter units, which respectively feed their own solid angle segment of the detection field. Preferably, each emitter unit is in this case assigned its own reflector, by means of which the laser pulses enter the corresponding solid angle segment. The emitter units may then, for example, emit sequentially during operation so that the laser pulses successively enter the different solid angle segments (respectively while waiting for a pause interval corresponding to the distance).

In a preferred configuration, the reflection surfaces of the different reflectors are tilted relative to one another, the different solid angle segments being covered by this relative tilting of the reflection surfaces. In general, this may for example also be achieved by means of the optical unit, or emitter units mounted with a tilt relative to one another; however, the latter implies increased mounting outlay and is therefore less preferred than tilting of the reflection surfaces.

According to one preferred embodiment, the distance-measuring unit comprises a plurality of receiver units, each of which has a sensitive sensor surface. Preferably, each of these sensor surfaces is then respectively assigned its own reflector. This means that the reflector and the receiver unit are positioned relative to one another in such a way that a perpendicular projection of the reflection surface into the sensor surface fills the latter partially but not fully. In general, the respective sensor surface may also be assigned a plurality of reflectors, exactly one reflector per sensor surface is preferred.

In general, a resolution along two axes may advantageously be provided by the combination of a plurality of sensor surfaces and reflectors, i.e. the detection field may in principle be scanned two-dimensionally. If the sensor surfaces are for example arranged in a row next to one another, the detection field may be resolved along this axis on the receiver side (echo pulses returning from different segments strike different sensor surfaces). The relative tilting of the reflection surfaces may then preferably be fanned out along an axis perpendicular thereto, so that two-dimensional or grid-like scanning is obtained overall.

According to one preferred embodiment, the laser pulses of the different emitter units are guided into the detection field through the same optical unit. The advantages mentioned in the introduction of multiple use or compact arrangement to this extent come into play particularly greatly.

Again relating to the optical unit in general, i.e. independently of the assignment of a plurality of emitter units: as an alternative to a lens, in general a holographic structure for guiding radiation may for example also be envisioned. The lens preferably provided may, however, also be constructed more complexly, for example as a microlens array or gradient-index lens. A lenticular lens may likewise be provided, i.e. one which is translationally symmetrical along one axis.

In a preferred configuration, however, the optical unit is a converging lens, preferably having a locally different radius of curvature. In particular, a smaller radius of curvature (stronger curvature) may be preferred centrally and a larger radius of curvature (lower curvature) may be preferred peripherally, the central region being assigned to the reflector and therefore to the emitter unit, and the echo pulses travelling through the edge region onto the sensor surface.

As mentioned in the introduction, according to one preferred embodiment, a laser diode as the emitter unit and a photodiode as the receiver unit may be structured on a common semiconductor substrate. This may in particular be done with a laser diode configured as a surface emitter, which is for example constructed on the basis of GaAs (GaAs/AlGaAs). Photodiodes may also be produced on the basis of III-V compound semiconductors, and are thus located in the same system. Correspondingly, the laser diode and the photodiode may already be combined at the wafer level, i.e. produced in the same front-end process.

The emission of the surface emitter takes place perpendicularly to its surface, i.e. perpendicularly to the sensor surface. The laser diode and the photodiode may then, for example, be placed directly next to one another (on the same substrate). A more extensive geometrical restriction is however also possible, that is to say for example the sensor surface may enclose the laser diode, i.e. have a ring shape (for example annular shape), the laser diode being seated therein.

The invention also relates to the use of a distance-measuring unit as disclosed here in a motor vehicle, for example a truck or motorcycle, and in an automobile. Application in a semiautonomously or fully autonomously driving vehicle is particularly preferred. In general, however, application in an aircraft or watercraft may also be envisioned, for instance an airplane, a drone, a helicopter, train or ship. Further application fields may be in the field of indoor positioning, i.e. detecting the positions of persons and objects inside buildings; detection of a plant structure (morphological recognition in plant cultivation) is also possible, for example during a growth or ripening phase; applications may also be in the field of the control (tracking) of effect lighting in the field of entertainment, the control (tracking) of a robotic arm in the fields of industry and medicine likewise being possible.

### BRIEF DESCRIPTION OF THE DRAWINGS

The invention will be explained in more detail below with the aid of an exemplary embodiment; the individual features in the scope of the coordinated claims may also be essential to the invention in a different combination, and distinction is furthermore not made in detail between the various claim categories.

In detail:

FIG. 1 shows a distance-measuring unit according to the invention in a schematic cross section;

FIG. 2 shows a plan-view representation of the distance-measuring unit according to FIG. 1;

FIG. 3 shows a detail view of FIG. 1;

FIG. 4 shows a further distance-measuring unit according to the invention in a schematic cross section;

FIG. 5 shows a plan view of the distance-measuring unit according to FIG. 4;

FIG. 6 shows a possibility of the configuration of the reflector of a distance-measuring unit according to the invention;

FIG. 7 shows a possibility of the integration of the laser diode and photodiode.

### PREFERRED EMBODIMENT OF THE INVENTION

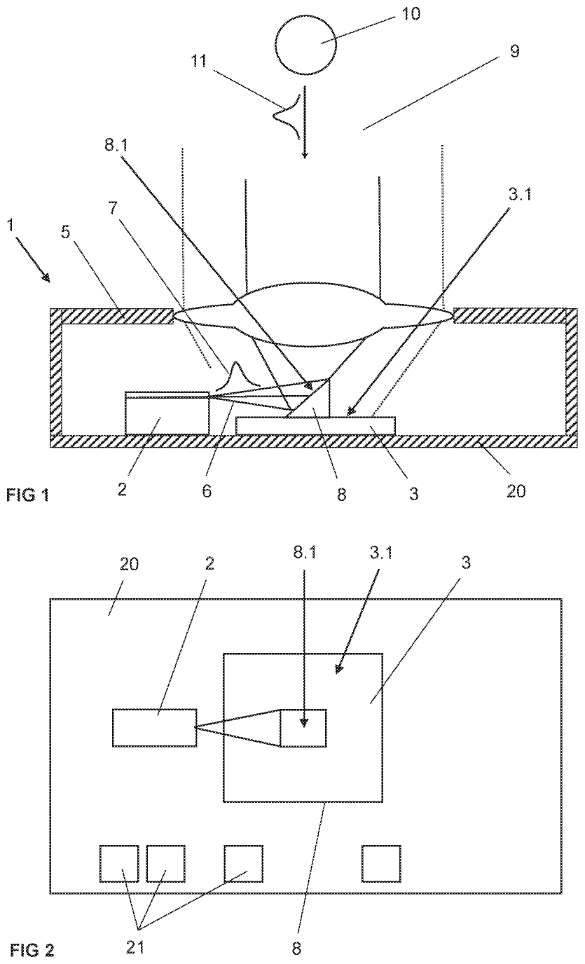

FIG. 1 shows a distance-measuring unit 1 according to the invention in cross section. It comprises an emitter unit 2, in the present case a laser diode, specifically an edge emitter. The distance-measuring unit 1 furthermore comprises a receiver unit 3, which has a sensitive sensor surface 3.1. Radiation incident on the latter can be metrologically detected (converted into an electrical signal) and processed, in a manner which is of no further relevance here. The distance-measuring unit furthermore comprises an optical unit 4, specifically a converging lens. The optical unit 4 is fitted into a housing 5, in which the components mentioned above are also accommodated.

The emitter unit 2 is adapted to emit laser radiation 6, and can thus emit laser pulses 7 during operation. These are guided by means of a reflector 8, after reflection at the reflection surface 8.1 of the latter, through the optical unit 4 and therefore into the detection field 9. If there is an object 10 there, radiation is partially reflected back at its surface and thus returns in the form of echo pulses 11 to the distance-measuring unit 1. The echo pulses 11 pass through the same optical unit 4 as the one through which the laser pulses 7 emerge, and are guided onto the sensor surface 3.1. From the time lag which exists between the emission of the laser pulse 7 and the reception of the echo pulse 11, with the speed of light c it is possible to determine the distance to the object 10 (which is then done in an evaluation or computer unit, for example an ASIC).

As may be seen from FIG. 1, the same optical unit 4 is used for the laser pulses 7 and the echo pulses 11, which gives a compact structure. This is possible because of the radiation coupling via the reflector 8, by means of the reflection surface 8.1 of which the laser pulses 7 are guided into the beam path of the echo pulses 11.

FIG. 2 shows a part of the distance-measuring unit 1, specifically a substrate 20 with the emitter unit 2 and the receiver unit 3 thereon, in a plan view. The reflection surface 8.1 of the reflector 8 partially shadows the sensor surface 3.1, although sufficient radiation of the echo pulses 11 still reaches the sensor surface 3.1. Schematically indicated bonding pads 21, by means of which the individual components can be contacted, may furthermore be seen in the plan view.

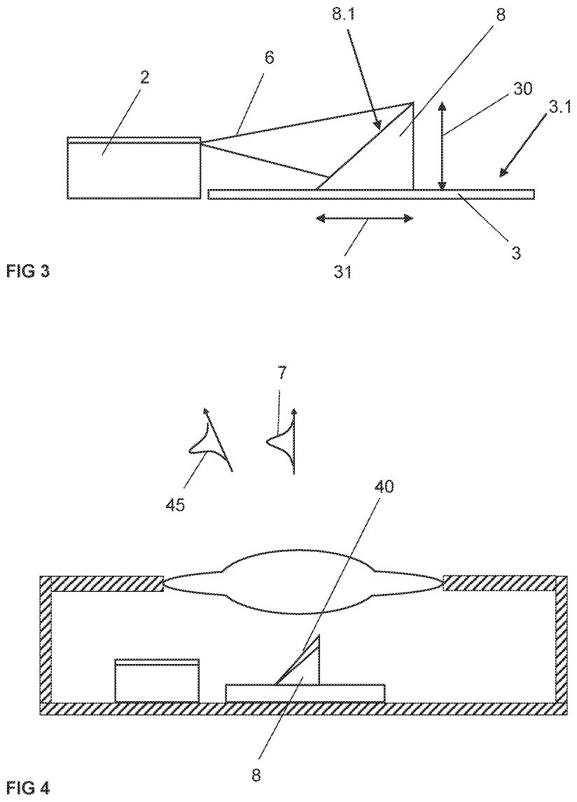

FIG. 3 shows a detail view of the cross section according to FIG. 1. The laser radiation 6 emerges with an aperture angle of around 19° (fast axis) and the receiver unit 3 has an edge length of 1.3 mm. If the emitter unit 2 is placed directly at the edge, the required size of the prismatic reflector 8 may be estimated therefrom; it must have a height 30 of about 0.22 mm and a length 31 of about 0.07 mm (in the case of an emission angle of 45°). Only a surface fraction of around 1% of the sensor surface 3.1 is therefore shadowed in principle. The width, extending into the plane of the drawing, of the prism or of the reflective body is given the width of the slow axis.

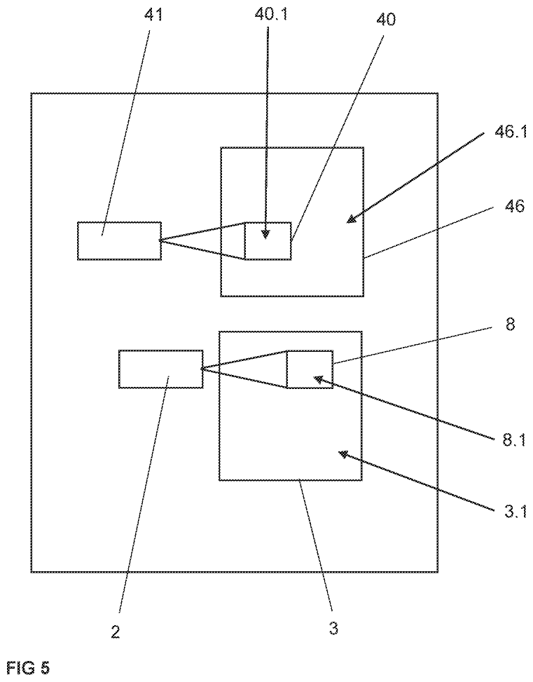

FIG. 4 shows a further distance-measuring unit 1 according to the invention, parts having the same or a similar function generally being provided with the same references in the scope of this disclosure (and in this regard reference is also made to the other respective figures). As may already be seen in the schematic cross section, or the cross-sectional side view, in the variant according to FIG. 4 a further reflector 40 is arranged laterally offset behind the reflector 8. It is assigned a further emitter unit 41, cf. FIG. 5. As may in turn be seen from FIG. 4 when considered together with FIG. 5, the reflection surfaces 8.1, 40.1 of the reflectors 8, 40 are tilted relative to one another so that the laser pulses 7, 45 emitted by the various emitter units 2, 41 enter different solid angle segments. Solid angle-resolved scanning of the detection field 9 is therefore possible, and distance images may be generated.

In the variants described above, the reflectors 8, 40 were respectively placed directly onto the respective sensor surface 3.1, 46.1 of the respective receiver unit 3, 46, i.e. they were adhesively bonded onto the small prismatic bodies. In this case, a (for example metallic) coating forms the respective reflection surface 8.1, 40.1.

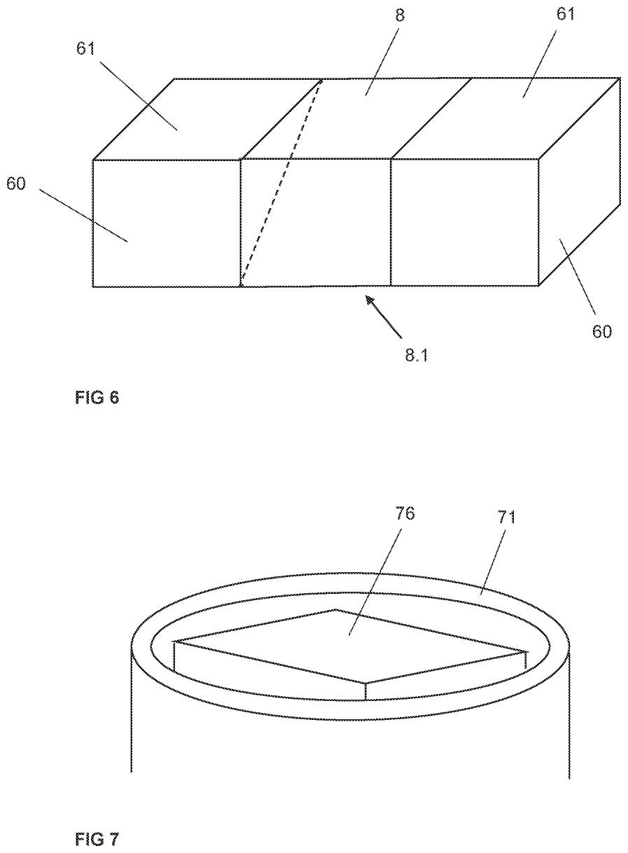

FIG. 6 illustrates an alternative thereto, namely a reflector 8 which is likewise arranged above the sensor surface 3.1 but is carried by suspension elements 60. The reflector 8 and the suspension elements 60 are formed monolithically from a radiation-transmissive material, in the present case from quartz glass. The suspension elements 60 are fastened laterally outside the sensor surface 3.1, although this is not represented in detail here. In order to reduce reflection losses (for example Fresnel reflections), the suspension elements 60 are provided at least locally with an antireflection coating 61.

In the present case, the reflection surface 8.1 is a total internal reflection surface, the laser pulses 7 enter the prismatic quartz glass reflector, are totally internally reflected and then emerge (upward).

FIG. 7 illustrates a schematic representation of a possibility of the wafer-level integration of the emitter unit 2 and the receiver unit 3, the former being provided as a surface emitter 70, for example a VCSEL emitter, and the latter as a photodiode 71, preferably an avalanche photodiode based on a III-V semiconductor. Both are produced on the basis of GaAs in the course of the same semiconductor fabrication. The sensor surface will in practice be larger than in this schematic representation.

### LIST OF REFERENCES

distance-measuring unit 1
emitter unit 2
receiver unit 3
sensor surface 3.1
optical unit 4
housing 5
laser radiation 6
laser pulses 7
reflector 8
reflection surface 8.1
detection field 9
object 10
echo pulses 11
substrate 20
bonding pads 21
height 30
length 31
reflector (further) 40
reflection surface (further) 40.1
emitter unit (further) 41
laser pulses (further) 45
receiver unit (further) 46
sensor surface (further) 46.1
suspension elements 60
antireflection coating 61
surface emitter 70
photodiode 71

1. A distance-measuring unit for measuring a distance to an object located in a detection field based on a time-of-flight signal, comprising:
an emitter unit for emitting laser pulses,
an optical unit coupling the emitter unit to the detection field, the optical unit configured to guide the laser pulses into the detection field during operation, and
a receiver unit having a sensitive sensor surface for receiving laser pulses reflected at the object as echo pulses,
wherein the receiver unit is coupled to the detection field by means of the optical unit such that the echo pulses received from the detection field are guided through the optical unit onto the sensor surface during operation.

2. The distance-measuring unit as claimed in claim 1, further comprising a reflector having a reflection surface at which the laser pulses are reflected through the optical unit during operation, wherein the reflector is arranged between the emitter unit and the optical unit.

3. The distance-measuring unit as claimed in claim 2, wherein the reflector and the receiver unit are positioned relative to one another in such a way that a perpendicular projection of the reflection surface into the sensor surface fills the sensor surface partially but not fully.

4. The distance-measuring unit as claimed in claim 3, wherein the reflector is placed onto the sensor surface and connected thereto.

5. The distance-measuring unit as claimed in claim 3, wherein the reflector is fastened by means of a suspension element, which extends beyond an edge of the sensor surface and is fastened there.

6. The distance-measuring unit as claimed in claim 2, wherein the reflector comprises a prismatic body made of a radiation-transmissive material.

7. The distance-measuring unit as claimed in claim 6, wherein the reflection surface is a total internal reflection surface wherein the laser pulses enter the radiation-transmissive material of the reflector and emerge after total internal reflection at the reflection surface.

8. The distance-measuring unit as claimed in claim 6, wherein the suspension element is provided monolithically with the reflector and made of the same radiation-transmissive material.

9. The distance-measuring unit as claimed in claim 1, wherein the distance-measuring unit is configured to emit the laser pulses into different solid angle segments of the detection field.

10. The distance-measuring unit as claimed in claim 9, further comprising a further emitter unit having an associated further reflector;
wherein the emitter unit is associated with a reflector and each emitter unit, along with its respective reflector, are assigned to its own solid angle segment.

11. The distance-measuring unit as claimed in claim 10, wherein reflection surfaces of the reflectors are tilted relative to one another.

12. The distance-measuring unit as claimed in claim 10, further comprising a further receiver unit having a further sensor surface, each sensor surface respectively being assigned its own reflector.

13. The distance-measuring unit as claimed in claim 10, wherein the laser pulses of different emitter units are guided into the detection field by the optical unit.

14. The distance-measuring unit as claimed in claim 1, wherein the emitter unit is a laser diode and the receiver unit is a photodiode, the laser diode and the photodiode being structured on a common semiconductor substrate.

15. The use of a distance-measuring unit as claimed in claim 1, wherein the distance-measuring unit is within a motor vehicle and is configured to measure distances based on time-of-flight signals.
